(19) United States
(12) Patent Application Publication
(10) Pub. No.: US 2003/0104804 A1
(43) Pub. Date: Jun. 5, 2003

(54) Method and apparatus for ordering goods and services

(76) Inventor: Yoichi Iwata, Ann Arbor, MI (US)

Correspondence Address: Thomas E. Anderson, Gifford, Krass, Groh, Sprinkle,, Anderson & Citkowski, P.C., 280 North Old Woodward, Suite 400, Birmingham, MI, 48009, US

(21) Appl. No.: 10/005,039

(22) Filed: Dec. 4, 2001

(51) Int. Cl. H04M 3/42

(52) U.S. Cl. 455/414; 455/456

(57) ABSTRACT

An apparatus for ordering goods or services which are advertised or promoted on a broadcast medium, such as a radio station. The apparatus includes a client terminal which may be mounted in a vehicle such as an automobile. The client terminal includes a radio transmitter for transmitting information to a service center. The client terminal also includes a push button for activation to place an order for merchandise. The signal includes the vehicle location, terminal identification, date and the frequency of the radio receiver. The service center utilizes this information to learn the identity of the merchandise being promoted and the merchant offering the merchandise. The service center then orders the merchandise for delivery to the client.

### FIELD OF THE INVENTION

The invention relates to a method and apparatus for ordering goods and services which are advertised over a broadcast medium.

### BACKGROUND OF THE INVENTION

Goods and services are frequently advertised on radio and television and the like. During the advertisements, contact information such as phone numbers, websites, and the like are provided. However, potential customers are not always ready to write down contact information for the provider of the product or services. This is a particular problem for drivers of vehicles who must attempt to copy the contact information when driving.

An apparatus which permits a user to obtain additional information about a product or services from a vehicle is disclosed in U.S. Pat. Nos. 5,703,795 and 5,949,492 to Mankovitz. When additional information, such as the title and artist performing a recording is desired, the user pushes a button representing the broadcast station being listened to on an apparatus mounted in a vehicle. A signal is sent to a service center. The service center receives the signal and communicates with the broadcast station to find out what recording was being broadcast and forwards the additional information to the operator's home by mail.

However, these systems do not permit the ordering of products or services and are limited to a particular broadcast area. Additionally, the buttons on the transmitter must be reidentified as the vehicle moves from one broadcast area to another. Finally, the system requires selecting from one of a number of buttons while the user is driving the vehicle.

It is an object of the invention to provide an apparatus and method of ordering goods and services promoted on a broadcast medium with the press of a button.

### SUMMARY OF THE INVENTION

A method and system for ordering goods and services which are being promoted on broadcast media from a remote location such as a vehicle having a broadcast receiver. The system includes a client terminal which is connected to a global positioning system (GPS) and the broadcast receiver. The client terminal includes an electronic control unit (ECU), a switch, and a transceiver. The ECU is connected to the broadcast receiver and GPS to receive the station to which the receiver is tuned, the geographic position of the GPS and the time. When the switch is activated by the user, the ECU produces a signal with the identification of the user, location of the broadcast receiver, the station to which the receiver is tuned, and the time at which the switch was initialized. The signal is transmitted to the service center by the transceiver which receives the signal and identifies the station to which the client is listening. The service center determines which product or service was being promoted when the switch was initiated and obtains contact information regarding the provider. The service center then contacts the provider and places an order for the services or merchandise which was being promoted and charges the sale to the client's account. The goods are then shipped by the provider to a location designated by the user.

### BRIEF DESCRIPTION OF THE DRAWINGS

FIG. 1 is a diagram of an ordering system in accordance with the invention;

FIG. 2 is a perspective view of an instrument display of a vehicle showing a client terminal and switch in accordance with the invention;

FIG. 3 is a diagrammatic view of the client terminal and peripheral equipment in accordance with the invention; and

FIG. 4 is a flow chart showing steps of the method in accordance with the invention.

### DETAILED DESCRIPTION OF THE PREFERRED EMBODIMENTS

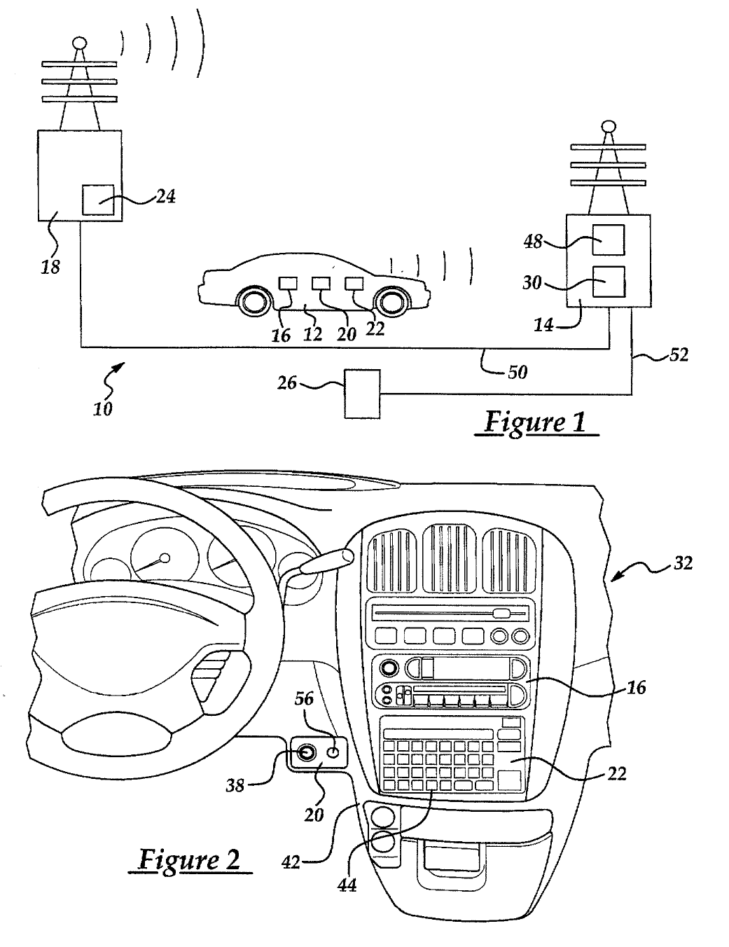

A system 10 for ordering goods or services from a remote location such as a vehicle 12 through a service center 14 as shown in FIG. 1. The vehicle 12 is equipped with a receiver 16 which receives a transmission from a broadcast medium such as a commercial radio station 18. Although the preferred embodiment is discussed with respect to a radio broadcast, the system may be utilized with other broadcast mediums such as television. The system is disclosed for use in a vehicle, however, the system may be utilized in connection with a building.

The system 10 also includes a client terminal 20 for ordering goods or services and a global positioning system (GPS) unit 22. The service center determines what product or service the user is attempting to order by accessing a log 24 of the radio station 18 and places an order from a merchant 26 promoting or providing the goods or services advertised on the radio station broadcast.

As shown in FIG. 2, orders are placed through the client terminal 20 which is mounted to an instrument panel 32 of the vehicle 12. The client terminal may alternatively be mounted at other places where easily accessible, such as a steering wheel. The radio receiver 16 and the GPS 22 are also mounted to the instrument panel.

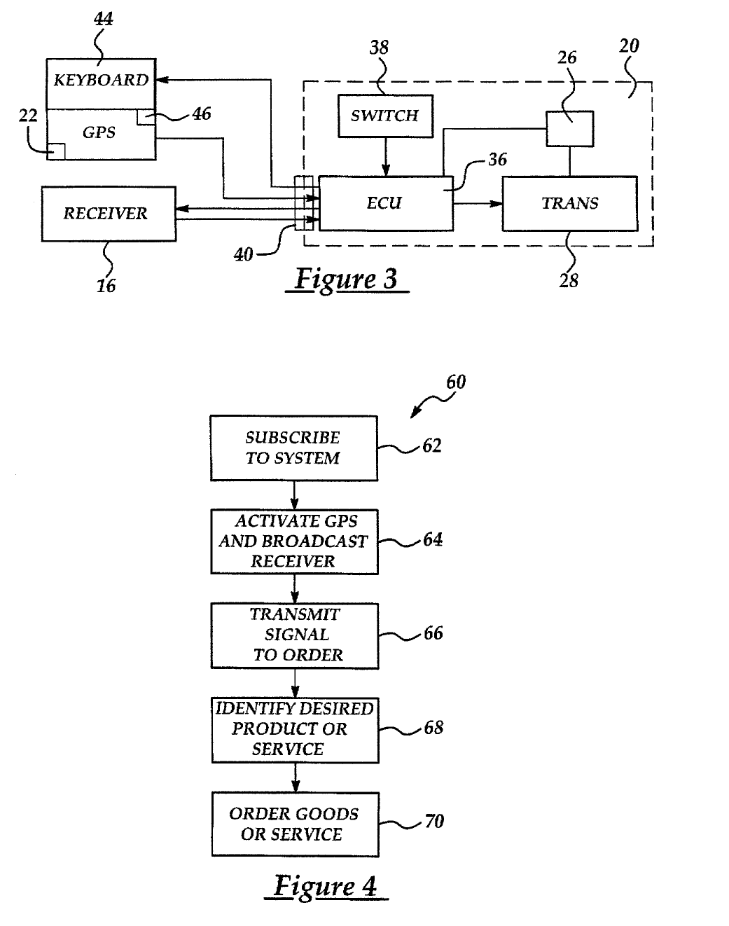

As shown in FIG. 3, the client terminal 20 includes a radio transmitter 34, electronic control unit (ECU) 36, and a switch or pushbutton 38 connected to the electronic control unit 36. The client terminal 20 is mounted to the vehicle so that the push button 38 is readily accessible to the driver of the vehicle. An indicator light 56 may be provided to indicate the status of the system.

When the button 38 is pressed, the ECU reads the frequency to which the receiver 16 is tuned, the location and time from the GPS unit 22, and places the date into a file. The frequency and time are thus date stamped. This file is then delivered to the transceiver 28 which broadcasts this information along with the identity of the transceiver 28.

The client terminal has a data port 40 which permits connection of the ECU 36 to the receiver 16 and GPS unit 22. In the preferred embodiment, the vehicle 12 is equipped with the radio receiver 16 and the GPS 22 as standard equipment. However, the client terminal 20 can be provided as a stand alone unit having a broadcast receiver and/or a GPS unit incorporated into the client terminal. Alternatively, the elements of the client terminal could be incorporated into either or both the receiver and GPS unit.

In the preferred embodiment, the broadcast receiver 16 is a conventional radio receiver such as an AM/FM radio. Alternatively, the system can include a television receiver or both a television and radio receiver. The broadcast receiver 16 is connected to the client terminal 20 and ECU 36 such that the ECU 36 can obtain the frequency of any broadcast station to which the receiver 16 is tuned.

The GPS unit 22 shown in FIG. 2 is particularly adapted for use in navigating streets having a display 42 with a keyboard 44 for entry of data. As is known, GPS units have been used for some time in navigation in marine and aviation applications. GPS units used for navigation in land vehicles typically display a map and directions to a desired location. GPS units determine location using radio transmissions from satellites. The GPS unit receives the transmissions of at least one of the satellites and identifies each satellite. The GPS has a database which has the orbit information and a clock 46 which provides accurate time in order to know where a particular satellite is positioned at that time. Using this information, the GPS calculates its location. As shown in FIG. 3, the GPS unit 22 is connected to the client terminal 20 to provide the current position of the GPS unit 22 (latitude and longitude) and the current time from the clock 46.

The keyboard 44 can be connected to the ECU 36 to permit entry of information such as a security code to prevent unauthorized utilization of the system when the car is being operated by persons not authorized to use the system. In the preferred embodiment, the keyboard from the GPS is interfaced into the ECU to permit entry of the data. However, a separate keyboard may be provided. Alternatively, other types of authorization systems can be utilized, such as voice recognition or fingerprints and the like.

As shown in FIG. 1, the service center 14 has a receiver 48 adapted to receive the information transmitted by the transceiver 28 of the client terminal 20. The service center 14 also includes a client database 30 which includes information about the client, including billing and shipping address, security codes, as well as identification characteristics of the client's transmitter 28 and billing information. The service center 14 also has a communications link 50 to the log 24 of broadcast station 18. In the preferred embodiment, the communication link is a digital transmission via the Internet; however, the communication can be made by phone or the like.

The log 24 contains a record of what is being broadcast and at what time. The log 24 includes identity of advertising spots as well as programming such as recordings being played. The log 24 is kept for a number of purposes including billing, advertising clients for the advertising, as well as permitting computation of any royalties due for use of copyrighted material. The log also contains the identity of the merchant 26 providing the goods or services. A communications link 52 is also provided to the merchant 26. The communication link 52 to the merchant 26 permits the service center 14 to order merchandise or services from the merchant 26.

### Operation

As shown in FIG. 4, the method includes opening a client account 60 at the service center. The client subscribes to the system. The client's identification, billing information, and the client terminal identifier are entered into the database 30 at the service center. The client terminal may be activated whenever the vehicle power is on or only after entry of authorization such as a security code by way of the keypad 44. This prevents unauthorized use by other persons having access to the client terminal. After activation, a status light may be activated to indicate the status of the system.

A broadcast receiver and global positioning system unit and the client terminal must be activated 62. When the client wishes to procure goods or services promoted during the broadcast, the switch 38 is activated 64 to place an order. When the switch 38 is pressed, the ECU 36 places the frequency to which the receiver 16 is tuned and location in the form of latitude and longitude coordinates with the time from the GPS unit 22 into a file. This effectively date stamps the receiver frequency and vehicle location. This file is then delivered to the transceiver 28 which transmits this information along with an identifier of the client terminal to the service center 14.

When the service center 14 receives a transmission from a client terminal, the receiver records and stores the information in a storage device. The client database 30 is researched to learn the identity of the client and information regarding the client's account. The service center 14 then identifies the broadcast station 18 by using the GPS location and the frequency of the receiver. The service center searches a database having the identity of broadcast stations capable of being received by a receiver at the location to determine the identity of the broadcast station 18. The service center then accesses the log 24 of the broadcast station 18, and using the time forwarded by the client terminal 20, determines 68 what product or service was being promoted at the time of the order, as well as the merchant offering the goods or services being advertised when the switch 38 was initiated. The service center 14 then contacts the merchant 26 to place an order 70 for the services or merchandise with the seller. The service center 14 makes payment arrangements with the seller, and instructs the seller to deliver the goods to the client's delivery address. The service center 14 also notifies the client of the transaction by way of e-mail or the like.

The invention has been described wherein a person at a remote location may utilize an apparatus with a single push of a button to order goods or merchandise, music which is promoted on a broadcast segment of a radio or television show. Numerous substitutions, modifications can be undertaken without departing from the true spirit and scope of the invention as defined in the claims.

I claim:

1. A method of ordering a product or service promoted on a broadcast transmitted by a broadcast station, said method comprising:
receiving a signal from a remote transceiver at a service center, said signal having a client identification information, a frequency of said broadcast, a location where said broadcast was received, and a time when said broadcast was received;
identifying said broadcast station using said frequency and said location;
determining said product or said service promoted on said broadcast using said time; and
ordering said product or service.

2. The method of claim 1, wherein said determining step includes accessing a station log of said broadcast station to obtain an identity of said provider of said good or service.

3. The method of claim 2, wherein said ordering step includes contacting said provider of said service to order said product or service.

4. The method of claim 1, wherein said ordering step includes delivering said product or service to said client.

5. The method of claim 1, wherein before said receiving step, said method includes determining said location and said time with a global positioning system unit.

6. The method of claim 5 further including after determining said location step, the step of initiating said transceiver to transmit said information with a switch on a client terminal.

7. The method of claim 6, further including the step of connecting said client terminal to a broadcast receiver to access said frequency.

8. The method of claim 6, wherein said method further includes connecting said client terminal to a global positioning system unit to obtain said location and said time.

9. An apparatus for ordering a product or a service promoted during a broadcast received on a receiver, said apparatus interacting with a service center for ordering said product or service, said comprising:
a client terminal having an interface having an electronic control unit, a switch and a transceiver, said electronic control unit being interconnected with said broadcast receiver to obtain a frequency of a station to which said broadcast is tuned to receive, said electronic control unit connected with a global positioning system unit to receive a location where said global positioning system unit is located and time associated with said location, said switch operable to send a signal to said electronic control unit to transmit said frequency, said location, said associated time and a client identifier to said service center to facilitate ordering of said good or service.

10. The apparatus of claim 9, wherein said switch further comprises a push button.

11. The apparatus of claim 9, wherein said client terminal includes said global positioning system unit and said receiver.

12. The apparatus of claim 9, wherein said client terminal is mounted to a vehicle.

13. A system for ordering a product or service promoted during a broadcast received on a broadcast receiver, said system including:
a service center having a radio receiver and a database having client information;
a client terminal having an electronic control unit, a switch and transmitter, said client terminal connected to said broadcast receiver to obtain a frequency of a broadcast station to which said receiver is tuned, said electronic control unit connected with a global positioning system unit to receive a location of where said global positioning system unit is located, a time associated with said location, said switch operable to send a signal to said service center by said transceiver, said signal having a client terminal identifier, said location, said associated time and said frequency; and
a communication link between said service center and a log of a broadcast station for determining said product or service promoted during said broadcast.

14. The system of claim 13, further including a communication link between said service center and a provider of said goods and services.

15. The system of claim 13, wherein said client terminal is mounted to a vehicle.

16. The system of claim 13, wherein said switch is a push button.
